(19) United States
(12) Patent Application Publication
(10) Pub. No.: US 2009/0321692 A1
(43) Pub. Date: Dec. 31, 2009

(54) Nanostructured material comprising semiconductor nanocrystal complexes

(76) Inventors: Michael LoCascio, Clifton Park, NY (US); Margaret Hines, Troy, NY (US)

Correspondence Address: KENYON & KENYON LLP, 1500 K STREET N.W., SUITE 700, WASHINGTON, DC, 20005, US

(21) Appl. No.: 11/325,347

(22) Filed: Jan. 5, 2006

Related U.S. Application Data
(60) Provisional application No. 60/641,372, filed on Jan. 5, 2005.

(51) Int. Cl. H01B 1/00; H01B 1/02

(52) U.S. Cl. 252/518.1; 252/500

(57) ABSTRACT

A material and corresponding method of making a material are disclosed. The material includes a first semiconductor material and a plurality of core semiconductor nanocrystals dispersed in the first semiconductor material.

### CROSS-REFERENCE TO RELATED APPLICATIONS

The present application claims priority to U.S. Provisional Application No. 60/641,372, filed Jan. 5, 2005, which is incorporated by reference herein.

### FIELD OF THE INVENTION

The present invention relates generally to materials for use in thermoelectric devices and more particularly to semiconductor nanocrystal materials for use in thermoelectric devices and to methods of making semiconductor nanocrystal materials.

### BACKGROUND OF THE INVENTION

Quantum dot technology grew out of photonic material research in the late 1970s. Two research groups discovered that nanoparticles of semiconductor materials have a unique optical property that became known as quantum confinement. Alexander Efros and Alexie Ekimov were at the Yoffe Institute in Leningrad, Russia, and Louis Brus and his team were at Bell Laboratories. The discovery was that tiny crystals of Cadmium Selenide would fluoresce different colors when hit with light, depending upon the crystal size.

Semiconductor nanocrystals otherwise known as quantum dots are unique nanometer scale structures that are typically composed of II-VI, III-V, or IV-VI semiconductor materials. Quantum confinement effects are exhibited in nanocrystals as a result of their small diameter (2-10 nm) which is approximately the size of electron and hole wavefunctions. The unique electrical and optical properties exhibited by semiconductor nanocrystals are due to quantum confinement effects and may be manipulated by altering the size, shape, and composition of the quantum dots themselves. Quantum dots have a tunable absorption onset that has increasingly large extinction coefficients at shorter wavelengths, multiple observable excitonic peaks in the absorption spectra that correspond to the quantized electron and hole states, and narrowband tunable band-edge emission spectra. Semiconductor nanocrystals will absorb light at wavelengths shorter than the modified absorption onset and emit at, and only at, the band edge. Because they are inorganic, nanocrystals are more robust than organic molecules and organic fluorophores and do not substantially photobleach. This is particularly true when oxygen availability is limited. Nanocrystals may be surface modified with multiple layers of inorganic and organic coatings in order to manipulate the electronic states, control recombination mechanisms, and provide for chemical compatibility with the solvent or matrix material in which the nanocrystals are dispersed.

The tunable electronic band structure, small size and flexibility in device design afforded by quantum dots leads to the applicability to a number of energy conversion devices. There has been significant research over the past decade on photovoltaic and thermoelectric devices. Despite the apparent narrow focus, a number of different device designs exist for photovoltaic cells alone including P-N and P-I-N single or tandem QD junctions or hot carrier cells, intermediate band solar cells, dye sensitized cells (otherwise known as Gratzel cells), a variety of luminescent and luminescent concentrator cells, and extremely thin absorber (ETA) cells.

Thermoelectric devices that convert temperature differences directly into electric current can be greatly impacted by nanoscale semiconductor technologies. Efficient thermoelectric devices require materials that have large charge carrier mobilities and low heat transport via lattice vibrations (phonons). Unfortunately, these two properties do not generally occur together. Although small bandgap semiconductors such as PbTe, PbSe, and PbS are among the best materials, they have not achieved sufficient efficiencies to make thermoelectric devices useful to anything but niche applications. However, it has been found that semiconductor nanocrystals, composed of narrow band semiconductor compositions, can be used to circumvent many of the drawbacks present in traditional materials.

Colloidal semiconductor nanocrystals (or quantum dots) are small, spherical, crystalline particles of a given material consisting of hundreds to thousands of atoms. They are neither atomic nor bulk semiconductors, but may best be described as artificial atoms. Their properties originate from their physical size, which ranges from 10 to ˜100 Å in radius and is often comparable to or smaller than the bulk Bohr exciton radius. As a consequence, nanocrystals no longer exhibit their bulk parent optical or electronic properties. Instead, they exhibit novel electronic properties due to what are commonly referred to as quantum confinement effects. These effects originate from the spatial confinement of intrinsic carriers (electrons and holes) to the physical dimensions of the material rather than to bulk length scales. One of the better-known confinement effects is the increase in semiconductor band gap energy with decreasing particle size; this manifests itself as a size dependent blue shift of the band edge absorption and luminescence emission with decreasing particle size (FIG. 1a+b). As nanocrystals increase in size past the exciton Bohr radius, they become electronically and optically bulk-like. Therefore nanocrystals cannot be made to have a smaller bandgap than exhibited by the bulk materials of the same composition. However, by engineering the core and semiconductor shells in terms of size, thickness and composition, core to shell electronic transitions can be engineered that have below bandgap (of the core) emission.

The objective of the present invention is to produce a material comprising semiconductor nanocrystals with a high ZT bulk thermoelectric co-efficient. Furthermore, the present invention provides a method of making a material comprising a semiconductor nanocrystal in a first matrix material. The material of the present invention may have a high bulk thermoelectric co-efficient and, it may be manufactured by a cost effective processes that can lead to commercial viability.

The invention further provides a method of making cost effective, high ZT thermoelectric thin films that can be deposited onto inexpensive flexible substrates. The method of making the high ZT thin films includes the steps of preparing semiconductor nanocrystals, self assembling the semiconductor nanocrystals into a colloid crystal on a substrate and thermally fusing the shells surrounding the core semiconductor nanocrystals resulting in a thin film structure having closely spaced semiconductor nanocrystal cores suspended in a matrix comprising the fused shell semiconductor nanocrystal material. The resulting complex retains the benefits of semiconductor nanocrystal materials, such as tenability and high ZT and at the same time would be able to be able to be easily dispersed onto various substrates.

### SUMMARY OF THE INVENTION

The present invention provides a material and corresponding method of making a material that includes a first semiconductor material and a plurality of core semiconductor nanocrystals dispersed in the first semiconductor material.

### BRIEF DESCRIPTION OF THE DRAWINGS

FIG. 1 represents an example thermoelectric device.

FIG. 2 represents a unit less diagram showing the relationships of the Z components over a range of carrier concentrations.

FIG. 3 represents an example semiconductor nanocrystal complex according to an example embodiment of the present invention.

FIG. 4 represents a second example semiconductor nanocrystal complex according to a second example embodiment of the present invention.

FIG. 5 represents an example method of making an example semiconductor nanocrystal complex of the present invention.

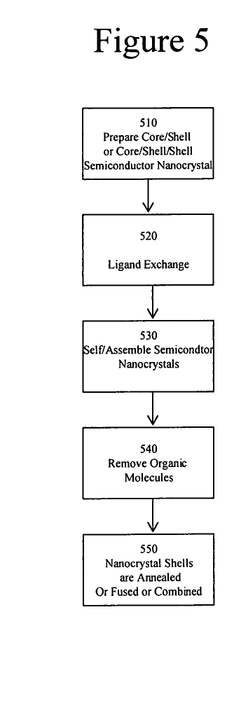

FIG. 6 represents a second example method of making an example semiconductor nanocrystal complex of the present invention.

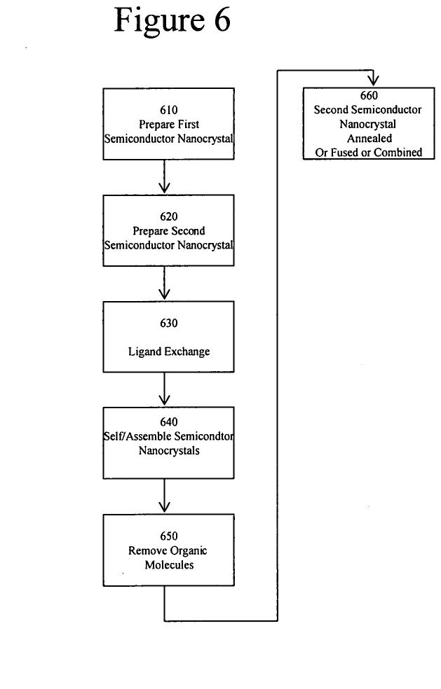

FIG. 7 represents a TEM image of 8 nm PbSe nanocrystal colloids

### DETAILED DESCRIPTION OF THE INVENTION

Semiconductor nanocrystals show promise for applications in a wide range of technologies because they exhibit narrow size-tunable emission and have a broad absorption spectrum. For this reason, a single source can excite a collection of nanocrystals that can, in turn, emit a broad spectrum of colors. Colloidal semiconductor quantum dots are small, spherical, crystalline particles of a given material consisting of hundreds to thousands of atoms. They are neither atomic nor bulk semiconductors, but may best be described as artificial atoms. Their properties originate from their physical size, which typically range from 10 to ˜100 Å in radius and is often comparable to or smaller than the bulk Bohr exciton radius. As a consequence, semiconductor nanocrystals do not exhibit their bulk parent optical or electronic properties. Instead, they exhibit novel electronic properties due to what are commonly referred to as quantum confinement effects.

These effects originate from the spatial confinement of intrinsic carriers (electrons and holes) to the physical dimensions of the material rather than to bulk length scales. One of the better-known confinement effects is the increase in semiconductor band gap energy with decreasing particle size; this manifests itself as a size dependent blue shift of the band edge absorption and luminescence emission with decreasing particle size. As nanocrystals increase in size past the exciton Bohr radius, they become electronically and optically bulk-like. Therefore nanocrystals cannot be made to have a smaller bandgap than exhibited by the bulk materials of the same composition. Properly engineering the core and semiconductor shells in terms of size, thickness and composition, core to shell electronic transitions can be engineered that have below bandgap (of the core) emission. Such nanocrystals are referred to as Type-II nanocrystals.

The emission wavelength of a semiconductor nanocrystal is determined by the nanocrystal size. Each individual nanocrystal emits a light with a line width comparable to that of atomic transitions. Any macroscopic collection of nanocrystals, however, emits a line that is inhomogeneously broadened due to the fact that every collection of nanocrystals is unavoidably characterized by a distribution of sizes. Presently the highest quality samples can be produced with size distributions exhibiting roughly a minimum 3-10% variation in nanocrystal volume. This directly dictates the width of the inhomogeneously broadened line.

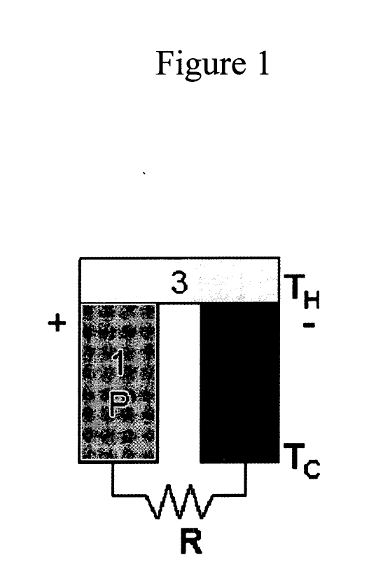

FIG. 1 presents a simple p-n thermoelectric junction consisting of a p-type (1) rod and an n-type (2) rod joined by a metallic bridge (3). The semiconductor rods have a temperature TH (hot) on the bridge end and a temperature TC (cold) at the opposite end. It is assumed that there exists a heat source on the hot side and a heat sink at the cold side, both of which act to maintain the temperature difference across the semiconductor rods. The cold side of the semiconductor rods is bridged with a resistance R which acts as a load for the electrical energy generated. The semiconductor nanocrystal materials of the present invention are ideally suited to act as either the p-type or n-type conductors represented in FIG. 1.

Semiconductors possess higher Seebeck coefficients than metals and hence are the material of choice for thermoelectric devices. In FIG. 1, if the semiconductor elements 1 and 2 were both of the same type, p or n, the voltage potentials produced by the temperature difference would both be directed in the same direction. Such a configuration would cause the temperature induced voltage potentials to oppose each other in the circuit. A more preferable configuration is to employ semiconductor rods of opposite conductivity mechanisms, as shown. In this configuration the induced voltages are additive, and the total induced voltage is the sum of the induced voltages in each rod.

The efficiency expression may be derived from Equation 2:

$$η = \frac{{T}_{H} - {T}_{C}}{{T}_{H}} \cdot \frac{\frac{m}{m + 1}}{1 + \frac{Kr}{{a}^{2}} \cdot \frac{m + 1}{{T}_{H}} - \frac{1}{2} \frac{( {T}_{H} - {T}_{C} )}{{T}_{H}} \cdot \frac{1}{m + 1}} . \qquad Equation 2$$

where, the thermal emf, a, is the sum of the thermal emf's of the two branches, or a=a1+a2. The thermal conductivities of the elements are denoted by K1 and K2, and the total thermal conductivity is denoted by K=K1 and K2. The quantity m is the ratio of the load resistance R to the total element resistance r. The efficiency expression shows that there are three dimensionless quantities that drive the efficiency of the thermoelectric device. The first is the ratio of the temperature difference to TH. This term is the efficiency of a reversible engine, which is what the thermoelectric junction would be if not for the presence of the non-reversible conduction and resistive power terms. This term causes the total efficiency to rise as the temperature difference increases. The second quantity is the ratio of the load resistance R and the combined element resistance r. The presence of this term indicates that the efficiency of a thermoelectric junction can be optimized to the applied load.

The first two dimensionless parameters in the efficiency equation are important in the design and performance analysis of the thermoelectric device based on specific temperature and load requirements. However, they do not reflect the fundamental material properties of the semiconductor elements themselves. The influence of the material properties on the thermoelectric efficiency is held by the dimensionless quantity

$$\frac{{T}_{H} {a}^{2}}{Kr} .$$

In practice, this term is redefined by replacing the resistance r and conductivity K with the resistivity p and specific conductivity, respectively. This removes the geometric dependency of the expression and focuses solely on the material characteristics themselves. An intrinsic, or materials, Figure of Merit ZT has now been defined as:

$$ZT = \frac{{a}^{2}}{κ ρ} T \qquad Equation 3$$

To be an effective thermoelectric material, a compound must possess a large Seebeck coefficient, a low resistivity and a low thermal conductivity. Conventional thermoelectric materials are bulk solid solution alloys. Numerous bulk materials have been extensively studied for decades and the best known bulk solution alloys have room temperature Figures of Merit on the order of ZT˜1. It is generally acknowledged that this value of ZT is near the limit for bulk material and hence improvement in ZT beyond this value is not likely. The upper limit for bulk material ZT is due to the physical interrelationships between the Seebeck coefficient a, the thermal conductivity, and the electrical conductivity p. An increase in a is generally accompanied by an increase in the resistivity p because of carrier density changes.

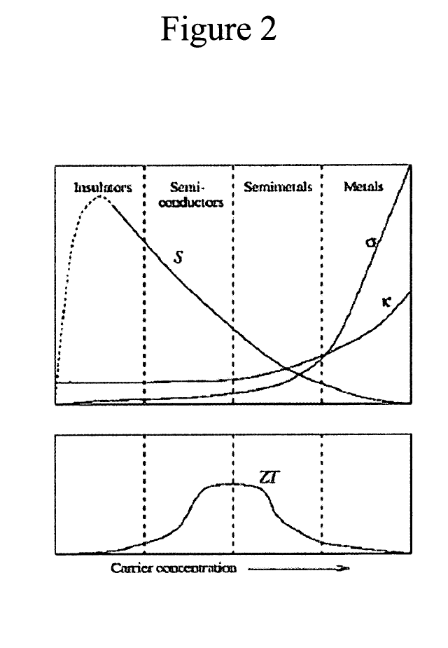

Furthermore a decrease in the resistivity implies an increase in the electrical contribution to the thermal conductivity. FIG. 2 is a unit less diagram showing the relationships of the Z components over a range of carrier concentrations. The ZT limit for conventional bulk thermoelectric materials is the reason for the historical relegation of this technology to a narrow band of applications. The positive aspects of this technology—no moving parts, long life, no emissions, low maintenance, etc., have been largely overshadowed by efficiency limitations that lead to high cost. The apparent upper limit to ZT understandably resulted in a severe slowdown in the development of technology over the period of time from approximately 1960 to 1990.

A superlattice is a periodic system of adjacent layers or monolayers which is synthetic and where a unit cell, consisting of successive layers that are chemically different from their adjacent neighbors, is repeated. The term quantum well multilayer applies to superlattices with artificially created electronic band structures. A three dimensional material may be prepared as a two dimensional multi-quantum well superlattice (a stacked layer system), a one dimensional superlattice (also known as a quantum wire), or a zero dimensional superlattice (an array of quantum dots). Because of the large surface to volume ratio and associated surface effects, as well as the capacity for artificially enhancing the density of states at the onset of each electronic subband, superlattice nanostructures are expected, and in some cases have been demonstrated, to exhibit dramatically different behaviors than bulk materials. This potential enhancement of material properties has generated a renewed interest in thermoelectrics. In particular, it has been predicted that the thermoelectric performance of any 3 D material can be enhanced by preparing the material as a lower dimensional quantum well superlattice.

Low dimensionality systems provide a number of possible levers that may be applied to the enhancement of the thermoelectric Figure of Merit. The quantum confinement permits the enhancement of the density of states near the Fermi energy EF. This enhancement leads to an enhanced Seebeck coefficient. The heterogeneities imposed at the lattice element boundaries provide the likelihood of increased phonon scattering, which leads to a reduction in the lattice contribution of thermal conductivity. Finally, under the necessary quantum confinement conditions, carrier mobilities may be increased so that modulation doping and delta doping cam be utilized. Theoretical calculations and experimental investigations of the thermoelectric properties of low dimensional 2-D and 1-D systems have been pursued extensively for various materials. The enhancement of thermoelectric performance is expected to increase with decreasing dimensionality. Therefore 0-D structures have the potential to provide maximum benefit to thermoelectric performance. 0-D structures most likely will take the form of superlattices of quantum dots.

### Semiconductor Nanocrystal Complexes

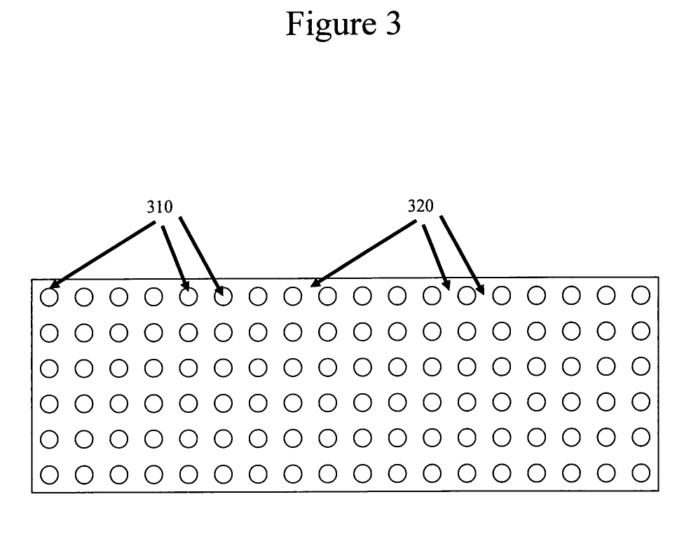

FIG. 3, represents an example material of an example embodiment of the present invention. 310 represents core semiconductor nanocrystals. As discussed above, core semiconductor nanocrystals are spherical nanoscale crystalline materials (although oblate and oblique spheroids and rods and other shapes may be nanocrystals) having a diameter between 1 nm and 20 nm and typically but not exclusively composed of II-VI, III-V, and IV-VI binary semiconductors. Examples of binary semiconductor materials that nanocrystals are composed of include ZnS, ZnSe, ZnTe, CdS, CdSe, CdTe, HgS, HgSe, HgTe (II-VI materials), PbS, PbSe, PbTe (IV-VI materials), AIN, AlP, AlAs, AlSb, GaN, GaP, GaAs, GaSb, InN, InP, InAs, InSb (III-V materials).

Lead salt nanocrystals, e.g. Lead Selenide, are ideal for acting as a high ZT material because of the small bandgap of the bulk material (0.27 eV) which enables spectral tunability over a large portion of the infrared spectrum. Currently PbSe nanocrystals are produced that have a first exciton peak in the range of 1000-2300 nm. In FIG. 2 the absorption spectra of various sizes of PbSe nanocrystals are shown. For all the spectra except for the “2300 nm” and “2000 nm” the short wavelength components of the absorption spectra have been removed in order to make the graph clearer.

Like other quantum dot materials PbSe will emit light at a wavelength dependent upon the nanocrystal size and absorb light at wavelengths shorter than the emission peak. PbSe nanocrystals grown to a diameter of 7.3 nm emit light at a peak wavelength of 1610 nm with a FWHM of 100 nm The peak emission wavelength occurs at a wavelength 60 nm longer than the first exciton peak due to Stokes shift.

320 represents an inorganic matrix material. The inorganic matrix material may be a second semiconductor material. The second semiconductor material may be any of the semiconductor nanocrystals materials discussed above. The inorganic matrix material is typically composed of a semiconductor material that has a lattice constant that matches or nearly matches the core and has a wider bulk bandgap than that of the core semiconductor.

The inorganic second material may have at one time been the shell around various semiconductor nanocrystal cores that was combined to form the matrix material through annealing, sintering or other process that unites the shells of the various semiconductor nanocrystals. Evaporation of capped semiconductor nanocrystal dispersions may produce the thin films in which the cap is weakly bound to the quantum dots. This cap can be removed, leaving a substantially inorganic superstructure. As the temperature is raised further, sintering, and grain growth occur, ultimately producing polycrystalline semiconductor nanocrystal thin films intercalated in a matrix material comprising a second semiconductor nanocrystal.

Additionally, the inorganic second material may have at one time been a group of second semiconductor nanocrystal cores that were combined to form a matrix material through annealing, sintering or other process that unites the shells of the various semiconductor nanocrystals. In this situation it would be preferable to initially create to populations of semiconductor nanocrystal cores wherein one population of cores has a higher melting point then the other. The group of nanocrystal cores with the lower melting point may be combined such that they form a matrix material surrounding the group of nanocrystal cores with the higher melting point.

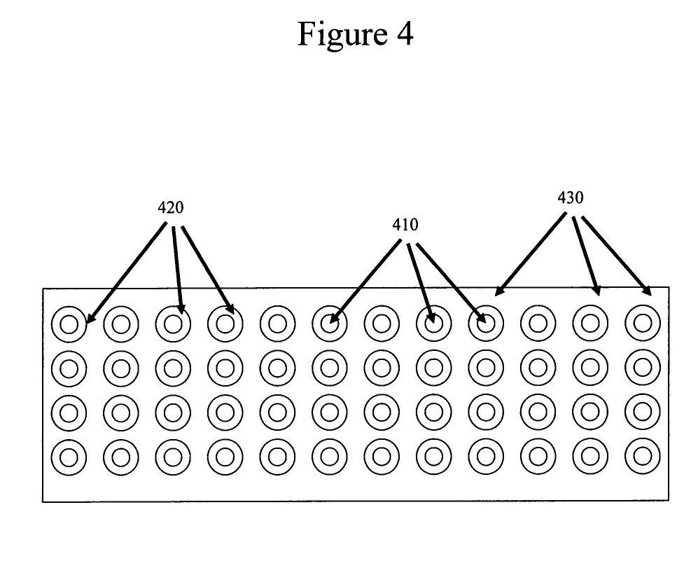

FIG. 4, represents a second material according to a second embodiment of the present invention. In this example embodiment, instead of semiconductor nanocrystal cores, core/shell semiconductor nanocrystals are represented inside the matrix material 420. The core semiconductor nanocrystals 410 may be the same as those described in FIG. 3, in regard to 310. Examples of materials that may comprise the shells include CdSe, CdS, CdTe, ZnS, ZnSe, ZnTe, HgS, HgSe, HgTe, InP, InAs, InSb, InN, GaN, GaP, GaAs, GaSb, PbSe, PbS, and PbTe. The shell is typically between 0.1 nm and 10 nm thick and composed of one or more semiconductor material that has a lattice constant that matches or nearly matches the core and has a wider bulk bandgap than that of the core semiconductor.

Shell 420 may be around the semiconductor nanocrystal core 410 and is typically between 0.1 nm and 10 nm thick. Shell 420 may provide for a type A semiconductor nanocrystal complex. Shell 420 may comprise various different semiconductor materials such as, for example, CdSe, CdS, CdTe, ZnS, ZnSe, ZnTe, HgS, HgSe, HgTe, InP, InAs, InSb, InN, GaN, GaP, GaAs, GaSb, PbSe, PbS, and PbTe.

430 represents an inorganic matrix material. The inorganic matrix material may be a third semiconductor material. The third semiconductor material may be any of the semiconductor nanocrystals materials discussed above. The inorganic matrix material is typically composed of a semiconductor material that has a lattice constant that matches or nearly matches the core and has a wider bulk bandgap than that of the core semiconductor.

The inorganic third material may have at one time been the shell around the semiconductor nanocrystal shells 420 that were combined to form the matrix material through annealing, sintering or other process that unites the shells of the various semiconductor nanocrystals. Evaporation of capped semiconductor nanocrystal dispersions may produce the thin films in which the cap is weakly bound to the quantum dots. This cap can be removed, leaving a substantially inorganic superstructure. As the temperature is raised further, sintering, and grain growth occur, ultimately producing polycrystalline semiconductor nanocrystal thin films intercalated in a matrix material comprising the third semiconductor nanocrystal.

Additionally, the inorganic third material may have at one time been a group of second semiconductor nanocrystal cores that were combined to form a matrix material through annealing, sintering or other process that combines the second semiconductor nanocrystal cores. In this situation it would be preferable to initially create two populations of semiconductor nanocrystal cores wherein one population of cores has a higher melting point then the other. The group of nanocrystal cores with the lower melting point may be combined such that they form a matrix material surrounding the group of nanocrystal cores with the higher melting point.

The material represented by FIGS. 3 and 4 may be used in the thermoelectric device depicted in FIG. 2 and described above. The material may be used as a P or an N due to its high thermoelectric co-efficient. Depending on the composition selected for the underlying semiconductor nanocrystal in the materials the material can be constructed to either conduct electrons or holes.

### Method of Making Material

Synthesis of colloidal semiconductor nanocrystals was established in academia over a decade ago and is used to prepare size-tunable monodisperse quantum dots for a variety of material systems. In general, the process entails controlled injection of organometallic semiconductor precursors, in the form of an oxide or salt, in to a heated bath of coordinating ligands. Subsequently by controlling reaction conditions a discrete nucleation event occurs and results in homogeneous clusters of the desired semiconductor material. The temperature of the cluster solution is tuned to yield nanocrystal growth through accretion of the precursor monomers remaining in solution. The choice of coordinating ligand is governed by the requisite binding energy between the ligand and surface metal atom; the ligand must sustain controlled growth via accretion while maintaining particle stabilization and preventing aggregation. When the growing nanocrystals reach the desired size, the reaction is halted by rapidly decreasing the temperature of the solution. The nanocrystals are then isolated and purified out of the growth solution by a series of precipitation and centrifugation steps.

There are many advantages of colloidal synthesis of semiconductor nanocrystals over other approaches including the ease and diversity of nanocrystal manipulation, feasibility of large scale production, and controlled production costs at the desired production level. Because the nanocrystals are isolatable colloidal particles, post processing steps exist that are not possible or viable with other methods of manufacture. Additional layers of an alternative semiconductor or inorganic material can be epitaxially grown onto the existing nanocrystal core. These layered heterostructured materials, referred to as core-shell nanocrystals, provide increased chemical and physical stability of the core material of interest. As well, heterostructured layering can alter the electronic structure of the material and thereby manipulate charge transport through the nanocrystal.

The nanocrystal growth process is essentially a two-step chemical synthesis proven to have high-product yields with tight specifications on both particle size and size distribution. This solution phase colloid synthesis is conducive to scale-up either through increased batch size or by continuous flow reactions using known and readily available chemical processing equipment.

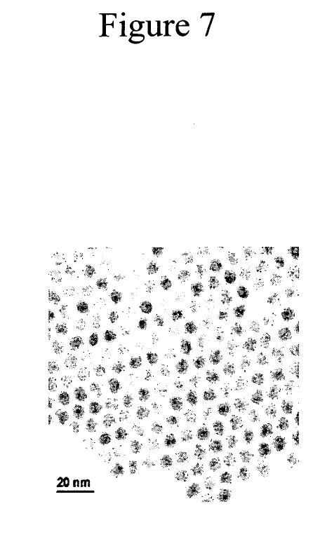

The present invention allows for the development of a process to synthesize 2-10 nm PbSe with PbS shells. A TEM image of 8 nm PbSe nanocrystal colloids is pictured in FIG. 7. Precise control over quantum dot size, shape, composition, and surface chemistry permits rational assembly of the nanocrystals into close-packed solids. The spacing between quantum dots in the solids can be varied from intimate contact to ˜50 angstroms. Glassy nanocrystal solids, with only short range order and random orientation, provide isotropic materials, whereas three-dimensional superlattices, ordered over hundreds of microns with preferred nanocrystal orientation, produce highly anisotropic media. The resulting material preferably has a thermoelectric constant above 1.0. More preferably, the resulting material has a thermoelectric constant above 1.5. Most preferably, the resulting material has a thermoelectric constant above 2.0.

In step 510, core/shell semiconductor nanocrystals are prepared in a solvent, e.g., TOPO. Preparations methods for core/shell semiconductor nanocrystals are well known in the art. In addition, core/shell semiconductor nanocrystals may be purchased from various commercial suppliers of semiconductor nanocrystals. In addition to core/shell semiconductor nanocrystals, core/shell/shell semiconductor nanocrystals may be used for the present invention. A core/shell/shell semiconductor nanocrystal is identical to a core/shell semiconductor nanocrystal however an additional shell of a third semiconductor material is grown around the core/shell semiconductor nanocrystal. Preparations methods for core/shell/shell semiconductor nanocrystals are well known in the art. In addition, core/shell/shell semiconductor nanocrystals may be purchased from various commercial suppliers of semiconductor nanocrystals.

In step 520, the initial ligands may be exchanged for pyridine ligands in solution. The solution phase synthesis of semiconductor nanocrystals, whether they are core semiconductor nanocrystals, core/shell semiconductor nanocrystals or core/shell/shell semiconductor nanocrystals often results in a semiconductor nanocrystal complex where each nanocrystal is capped by a molecular layer of a metal chelating ligand, e.g., tri-octyl phosphine oxide (TOPO). Because metal chelating ligands such as TOPO are often strongly bound to the nanocrystal surface, it is difficult to remove the chelating ligands after the semiconductor nanocrystals have been assembled into a thin film colloid.

Additionally, often chelating ligands, such as vestigial TOPO, can disrupt the annealing process through which the outer shell of each nanocrystal are combined. Thus, in order to create self assembled nanocrystal colloid crystal thin films that are free of organic impurities, pyridine or another weakly binding ligand may be substituted for the strongly bound metal chelating ligand. Although this process is described with TOPO as the initial ligand the nanocrystals are prepared and/or purchased in, there are many other strongly bonding ligands, or weakly bonding ligands, that semiconductor nanocrystals may be prepared and/or purchased in. In the event that the semiconductor nanocrystals used for purposes of the present invention are prepared or purchased in a ligand that can be driven off from the nanocrystal complex this step would not have to be prepared.

For example, the semiconductor nanocrystals may be prepared directly in a weakly bonding ligand, such as pyridine. Pyridine is a weakly bound ligand that will enable the quantum dots to remain in solution before being deposited into a colloid crystal thin film and subsequently evaporated away after quantum dot deposition.

In the event that it is determined that ligand exchange is desired, ligand exchange can be completed in three steps: 1) the ligand the nanocrystals are prepared in (i.e., TOPO) may be removed by repeated precipitation in a centrifuge, drawing off supernatant, and adding pure solvent; 2) after the original ligand is removed, pyridine (or other suitable ligand) may be added to the nanocrystals in solvent (they will initially be a precipitate); 3) finally, the nanocrystals can be resuspended in solvent with pyridine ligands by sonication.

In step 530, the resulting semiconductor nanocrystals are self-assembled in thin films on substrates. Evaporation of pyridine-capped nanocrystal dispersions produce thin films in which the pyridine is weakly bound to the quantum dots. Tailoring the composition of the dispersing medium to provide a slow destabilization of the quantum dot dispersion as the solvent evaporates will allow for the production of three-dimensional nanocrystal superlattices. The pyridine dots are re-dispersed in a solvent, the solvent after ligand exchange. For example, the semiconductor nanocrystal with organic stabilizers, e.g. pyridine, will be induced to order in a self assembled film by evaporating a nanocrystal dispersion composed of low boiling alkane and a high boiling point alcohol. As the dispersion is concentrated, the relative concentration of the alcohol rises, slowly reducing the steric barrier to aggregation and should cause a slow separation of the nanocrystals from the dispersed state to colloid crystal state. If the rate of the transition is carefully controlled, the sticking coefficient between the nanocrystals remains low and the arrival time of the quantum dots will be such that the nanocrystals have sufficient time to find equilibrium superlattices sites on the growing structure. In the arrival limited regime, nanocrystals have enough time to diffuse at the growing surface to form ordered solids.

In step 540, the organic molecules, i.e. pyridine, are thermally driven off from the self-assembled thin film. The self-assembled thin films resulting from step 530 is gently heated under vacuum. This heating drives off the weakly bound organic molecules from the films, leaving a substantially inorganic superstructure.

In step 550, the nanocrystal complex is annealed. As the annealing temperature is raised further, sintering, and grain growth occur, ultimately producing polycrystalline semiconductor thin films intercalated with nanocrystal cores. Thus, the shell material can be annealed. This results in semiconductor nanocrystals in a matrix material wherein the matrix material comprises the shell semiconductor nanocrystal. The resulting material preferably has a thermoelectric constant above 1.0. More preferably, the resulting material has a thermoelectric constant above 1.5. Most preferably, the resulting material has a thermoelectric constant above 2.0.

Once the material is annealed the material may be used as a P or an N due to its high thermo-electric co-efficient. Depending the composition selected for the underlying semiconductor nanocrystal in the materials the material can be constructed to either conduct electrons or holes.

In step 610, first semiconductor nanocrystals are prepared in a solvent. Preparations methods for semiconductor nanocrystals are well known in the art, including core semiconductor nanocrystals, core/shell semiconductor nanocrystals and core/shell/shell semiconductor nanocrystals.

In step 620, a second semiconductor nanocrystal may be prepared in a solvent. The second semiconductor nanocrystal should be selected such that it has a different melting point than the first semiconductor nanocrystal material. It has been found that the second semiconductor nanocrystal material may be a core semiconductor nanocrystal.

In step 630, in the event that the initial ligands are strongly bound to the surface of the first semiconductor nanocrystals and the second semiconductor nanocrystals these ligands may be exchanged for ligands that do not bind as strongly in solution, such as pyridine. The solution phase synthesis of semiconductor nanocrystals, whether they are core semiconductor nanocrystals, core/shell semiconductor nanocrystals or core/shell/shell semiconductor nanocrystals often results in a semiconductor nanocrystal complex where each nanocrystal is capped by a molecular layer of a metal chelating ligand, e.g., tri-octyl phosphine oxide (TOPO). Because metal chelating ligands such as TOPO are often strongly bound to the nanocrystal surface, it is difficult to remove the chelating ligands after the semiconductor nanocrystals have been assembled into a thin film colloid.

Additionally, often chelating ligands, such as vestigial TOPO, can disrupt the annealing process through which the outer shell of each nanocrystal are combined. Thus, in order to create self assembled nanocrystal colloid crystal thin films that are free of organic impurities, pyridine or another weakly binding ligand may be substituted for the strongly bound metal chelating ligand. Although this process is described with TOPO as the initial ligand the nanocrystals are prepared and/or purchased in, there are many other strongly bonding ligands, or weakly bonding ligands, that semiconductor nanocrystals may be prepared and/or purchased in. In the event that the semiconductor nanocrystals used for purposes of the present invention are prepared or purchased in a ligand that can be driven off from the nanocrystal complex this step would not have to be prepared.

For example, both the first semiconductor nanocrystals and the second semiconductor nanocrystals may be prepared directly in a weakly bonding ligand, such as pyridine. Pyridine is a weakly bound ligand that will enable the quantum dots to remain in solution before being deposited into a colloid crystal thin film and subsequently evaporated away after quantum dot deposition.

In the event that it is determined that ligand exchange is desired, ligand exchange can be completed in three steps: 1) the ligand the nanocrystals are prepared in (i.e., TOPO) may be removed by repeated precipitation in a centrifuge, drawing off supernatant, and adding pure solvent; 2) after the original ligand is removed, pyridine (or other suitable ligand) may be added to the nanocrystals in solvent (they will initially be a precipitate); 3) finally, the nanocrystals can be resuspended in solvent with pyridine ligands by sonication.

In step 640, the first semiconductor nanocrystals and the second semiconductor nanocrystals are mixed and self-assembled in thin films on substrates. The first semiconductor nanocrystals and the second semiconductor nanocrystal solutions should be mixed. The nanocrystals should be easily dispersible in each others solution.

Evaporation of the nanocrystal dispersions produce thin films in which the ligand is weakly bound to the quantum dots. Tailoring the composition of the dispersing medium to provide a slow destabilization of the quantum dot dispersion as the solvent evaporates will allow for the production of three-dimensional nanocrystal superlattices. The semiconductor nanocrystals capped with the weakly bound ligand are re-dispersed in a solvent, the solvent after ligand exchange. For example, the semiconductor nanocrystal with organic stabilizers, e.g. pyridine, will be induced to order in a self assembled film by evaporating a nanocrystal dispersion composed of low boiling alkane and a high boiling point alcohol. As the dispersion is concentrated, the relative concentration of the alcohol rises, slowly reducing the steric barrier to aggregation and should cause a slow separation of the nanocrystals from the dispersed state to colloid crystal state. If the rate of the transition is carefully controlled, the sticking coefficient between the nanocrystals remains low and the arrival time of the quantum dots will be such that the nanocrystals have sufficient time to find equilibrium superlattices sites on the growing structure. In the arrival limited regime, nanocrystals have enough time to diffuse at the growing surface to form ordered solids.

In step 650, the organic molecules, i.e. pyridine, of both the first and the second semiconductor nanocrystals are thermally driven off from the self-assembled thin film. The self-assembled thin films resulting from step 640 is gently heated under vacuum. This heating drives off the weakly bound organic molecules from the films, leaving a substantially inorganic superstructure. The substantially inorganic superstructure will contain both the first and the second semiconductor nanocrystals prepared in step 610.

In step 660, the nanocrystal complex is annealed. As the annealing temperature is raised further, sintering, and grain growth occur, ultimately producing polycrystalline semiconductor thin films intercalated with nanocrystal cores. The annealing should be conducted such that only the second semiconductor nanocrystal material anneals or sinters and the first semiconductor material remains suspended in the annealed second semiconductor material. The resulting material preferably has a thermoelectric constant above 1.0. More preferably, the resulting material has a thermoelectric constant above 1.5. Most preferably, the resulting material has a thermoelectric constant above 2.0.

Once the material is annealed the material may be used as a P or an N due to its high thermo-electric co-efficient. Depending on the composition selected for the underlying semiconductor nanocrystal in the materials the material can be constructed to either conduct electrons or holes.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A material comprising:
a first semiconductor material; and
a plurality of core semiconductor nanocrystals dispersed in the first semiconductor material.

2. The material of claim 1, wherein at least a portion of the first semiconductor material being formed from an annealed semiconductor nanocrystal shell surrounding the core semiconductor nanocrystals.

3. The material of claim 1, wherein the core semiconductor nanocrystal is a lead salt.

4. The material of claim 1, wherein the first semiconductor material is a lead salt.

5. The material of claim 1, wherein the thermoelectric constant of the resulting material is greater than 1.0.

6. The material of claim 1, wherein the thermoelectric constant of the resulting material is greater than 1.5.

7. The material of claim 1, wherein the thermoelectric constant of the resulting material is greater than 2.0.

8. A material comprising:
a first semiconductor material;
a plurality of core semiconductor nanocrystals dispersed in the first semiconductor material; and
a plurality of first semiconductor shells, a corresponding one of the first semiconductor shells surrounding a corresponding one of the core semiconductor nanocrystals.

9. The material of claim 8, wherein at least a portion of the first semiconductor material being formed from annealing a plurality of second semiconductor shells surrounding the first semiconductor shells.

10. The material of claim 9, wherein the core semiconductor nanocrystal is a lead salt.

11. The material of claim 8, wherein the first semiconductor material is a lead salt.

12. The material of claim 8, wherein the thermoelectric constant of the resulting material is greater than 1.0.

13. The material of claim 8, wherein the thermoelectric constant of the resulting material is greater than 1.5.

14. The material of claim 8, wherein the thermoelectric constant of the resulting material is greater than 2.0.

15. A method of forming a material, comprising:
forming a first semiconductor material; and
forming a plurality of core semiconductor nanocrystals dispersed in the first semiconductor material.

16. The method of claim 15, wherein the plurality of core semiconductor nanocrystals each include a semiconductor shell.

17. The method of claim 16, wherein forming the first semiconductor material comprises annealing or sintering the semiconductor shell.

18. The method of claim 15, wherein the plurality of core semiconductor nanocrystals each include two semiconductor shells.

19. The method of claim 15, wherein forming the first semiconductor material comprises annealing or sintering one of the semiconductor shells.

20. The method of claim 15, wherein the core semiconductor nanocrystals are a lead salt.

21. The method of claim 15, wherein the first semiconductor material is a lead salt.

22. The method of claim 15, wherein the thermoelectric constant of the resulting material is greater than 1.0.

23. The method of claim 15, wherein the thermoelectric constant of the resulting material is greater than 1.5.

24. The method of claim 15, wherein the thermoelectric constant of the resulting material is greater than 2.0.
